(19) United States
(12) Patent Application Publication
(10) Pub. No.: US 2012/0331389 A1
(43) Pub. Date: Dec. 27, 2012

(54) DOWNLOAD AREA MANAGEMENT

(75) Inventor: Scott R. VIOLET, Sunnyvale, CA (US)

(73) Assignee: GOOGLE INC., Mountain View, CA (US)

(21) Appl. No.: 13/166,692

(22) Filed: Jun. 22, 2011

(51) Int. Cl. G06F 3/048; G06F 15/16

(52) U.S. Cl. 715/738

(57) ABSTRACT

Methods for managing a download area of a browser are provided. A method includes determining whether a user has performed an action on an icon, representing a downloaded object, displayed within the download area in a primary window of the browser. The download area is configured to be active when the primary window is active. The method includes determining whether the user's cursor is positioned outside of the download area for at least a predetermined duration after the user has performed the action on the icon. The method includes automatically closing the download area if the user has performed the action on the icon and if the user's cursor is positioned outside of the download area for at least the predetermined duration.

### FIELD

The present invention generally relates to download area management of a browser.

### BACKGROUND

A web browser may provide a notification to a user that an object (e.g., an application, a multimedia file, a document, etc.) has been downloaded. However, providing this notification may direct the user's attention away from the user's browsing experience. For example, if the web browser opens a separate window to provide the notification to the user that the object has been downloaded, the user is left with multiple windows to manage, which may distract the user from using the web browser for other web browsing activities. Thus, it is desirable to provide the notification to the user that an object has been downloaded in such a manner that maximizes the user's browsing experience.

### SUMMARY

According to various aspects of the subject technology, a method for managing a download area of a browser is provided. The method includes determining whether a user has performed an action on an icon, representing a downloaded object, displayed within the download area in a primary window of the browser. The download area is configured to be active when the primary window is active. The method also includes determining whether the user's cursor is positioned outside of the download area for at least a predetermined duration after the user has performed the action on the icon. The method also includes automatically closing the download area if the user has performed the action on the icon and if the user's cursor is positioned outside of the download area for at least the predetermined duration

According to various aspects of the subject technology, a machine-readable storage medium encoded with instructions executable by a processing system to perform a method for managing a download area of a browser is provided. The instructions comprise code for determining whether a user has performed an action on an icon, representing a downloaded object, displayed within the download area in a primary window of the browser. The download area is configured to be active when the primary window is active. The instructions also comprise code for determining whether the user's cursor is positioned outside of the download area for at least a predetermined duration after the user has performed the action on the icon. The instructions also comprise code for automatically closing the download area if the user has performed the action on the icon and if the user's cursor is positioned outside of the download area for at least the predetermined duration.

According to various aspects of the subject technology, a method for managing a download area of a browser. The method comprises determining whether a user has performed an action on each of a plurality of icons displayed within the download area in a primary window of the browser. Each of the plurality of icons represents a downloaded object. The download area is configured to be active when the primary window is active. The method also comprises determining whether the user's cursor is positioned outside of the download area for at least a predetermined duration after the user has performed the action on each of the plurality of icons. The method also comprises automatically closing the download area if the user has performed the action on each of the plurality of icons and if the user's cursor is positioned outside of the download area for at least the predetermined duration.

Additional features and advantages of the subject technology will be set forth in the description below, and in part will be apparent from the description, or may be learned by practice of the subject technology. The advantages of the subject technology will be realized and attained by the structure particularly pointed out in the written description and claims hereof as well as the appended drawings.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide further understanding of the subject technology and are incorporated in and constitute a part of this specification, illustrate aspects of the subject technology and together with the description serve to explain the principles of the subject technology.

FIG. 1 illustrates an example of a browser, in accordance with various aspects of the subject technology.

FIG. 2 illustrates an example of a method for managing a download area of a browser, in accordance with various aspects of the subject technology.

FIG. 3 illustrates an example of an object represented by an icon being opened, in accordance with various aspects of the subject technology.

FIG. 4 illustrates an example of a browser having its download area closed, in accordance with various aspects of the subject technology.

FIG. 5 is a block diagram illustrating components of a controller, in accordance with various aspects of the subject disclosure.

### DETAILED DESCRIPTION

In the following detailed description, numerous specific details are set forth to provide a full understanding of the subject technology. It will be apparent, however, to one ordinarily skilled in the art that the subject technology may be practiced without some of these specific details. In other instances, well-known structures and techniques have not been shown in detail so as not to obscure the subject technology.

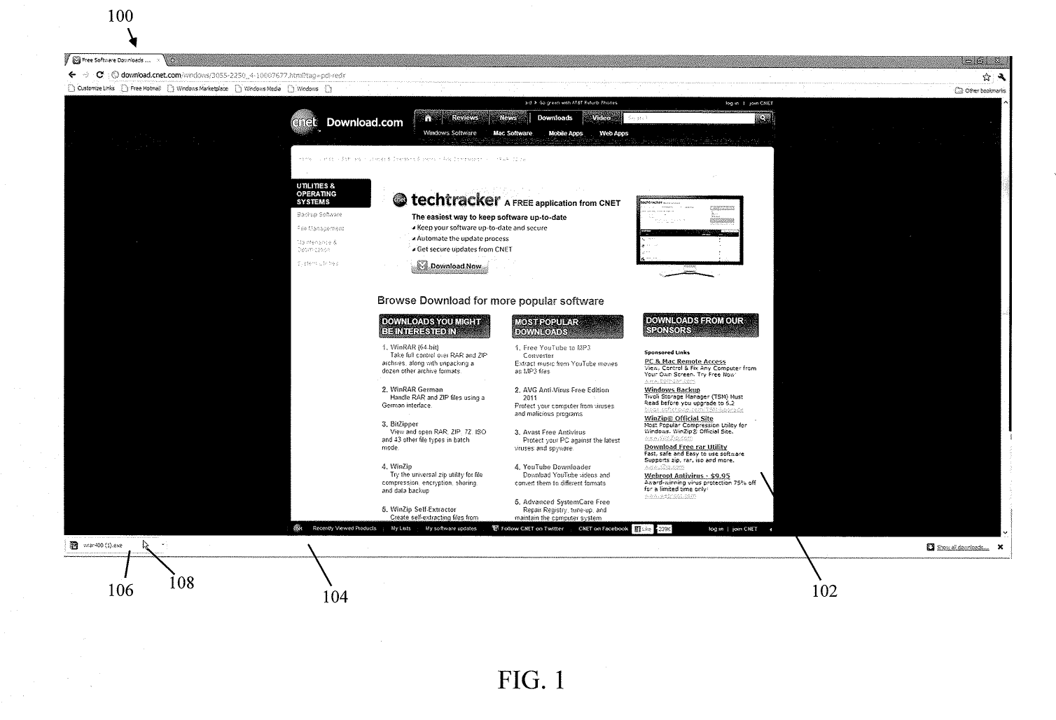

In order for a web browser to provide a notification to a user that an object has been downloaded, the browser may display certain content that represents the downloaded object. FIG. 1 illustrates an example of browser 100, in accordance with various aspects of the subject technology. Browser 100 comprises primary window 102, which may be used for viewing web pages. Browser 100 also comprises download area 104, which is an area that may display content representing one or more downloaded objects. In this regard, one or more icons may be used to represent a downloaded object. For example, as shown in FIG. 1, icon 106 is displayed within download area 104 and provides a notification to the user that a program entitled “wrar400(1).exe” has been downloaded. In some aspects, the term “icon” as used herein may encompass any suitable visual representation that may provide a notification to a user that an object has been downloaded. For example, an icon may include a button or some other suitable visual representation.

In some aspects, download area 104 is configured to be active when primary window 102 is active. In some aspects, download area 104 is integral with primary window 102. Thus, when a user is viewing primary window 102, the user may also view download area 104. This allows a user to continue to conduct web browsing activities using primary window 102 without having to switch back and forth between a different window that provides a notification of a downloaded object. In some aspects, download area 104 may run horizontally (e.g., a shelf) and/or vertically (e.g., a panel) along a border of primary window 102. However, download area 104 may be arranged in any suitable area relative to primary window 102. In some aspects, download area 104 may be a separate window from primary window 102.

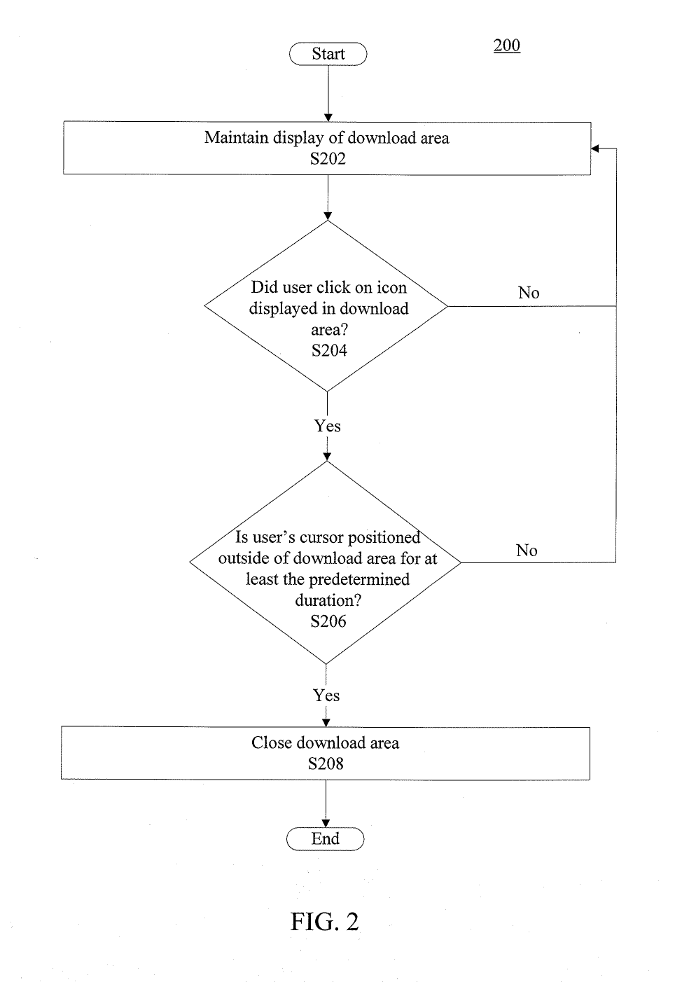

Aspects of the subject technology provide an approach for displaying one or more icons while maximizing the area available on primary window 102. FIG. 2 illustrates an example of method 200 for managing download area 104 of browser 100, in accordance with various aspects of the subject technology. According to S202, download area 104 is displayed to a user, for example as shown in FIG. 1. Download area 104 may be displayed in response to the user downloading a certain object. In this case, icon 106 is displayed within download area 104 to show that the program entitled “wrar400(1).exe” has been downloaded. At this point, the user may open the downloaded object, for example, by selecting and/or clicking on icon 106, as shown by the user's cursor 108 in FIG. 1. However, the subject technology is not limited to these actions for opening the downloaded object. Other suitable actions that are operable to open the downloaded object may be performed. Furthermore, these actions are not limited to being operable to open the downloaded object, but may be operable to manipulate the downloaded object in other suitable ways such as by saving the downloaded object to a particular location or displaying the downloaded object in a file explorer (e.g., if the user clicks on the arrow to the right of icon 106).

Aspects of the subject technology determine whether a user has clicked on a particular icon (or performed some other suitable action such as clicking on the arrow to the right of icon 106) displayed within the download area to open a corresponding downloaded object (or to manipulate the downloaded object in some other suitable way such as saving the corresponding downloaded object to a particular location or displaying the corresponding downloaded object in a file explorer depending on the action). According to S202 and S204, if the user did not click on icon 106 to open the downloaded object, then download area 104 remains displayed to the user. Thus, the user is reminded that an object has been downloaded but has not been opened yet. By maintaining the display of download area 104, the user is allowed to open the downloaded object at a later time.

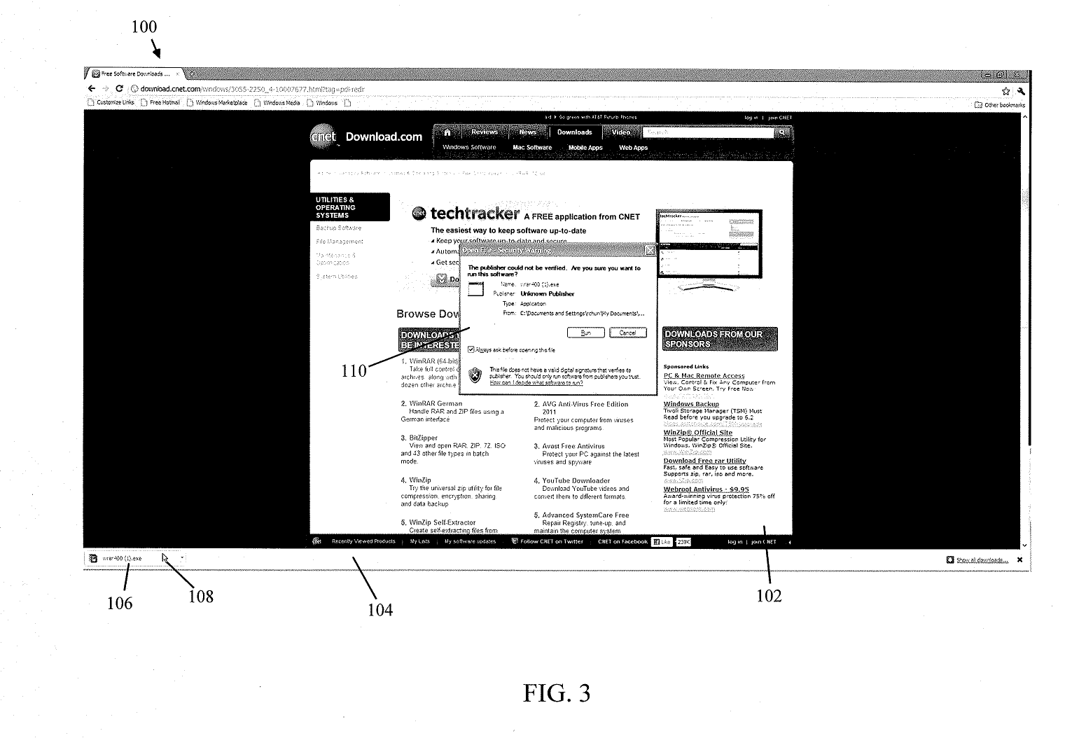

If the user did click on icon 106, then the downloaded object may be opened. FIG. 3 illustrates an example of an object represented by icon 106 being opened, in accordance with various aspects of the subject technology. In this case, once the user clicks on icon 106, window 110 is displayed to verify that the user wishes to open the downloaded object. At this point, download area 104 may be closed or may remain displayed depending on what the user's attention is directed to. For example, according to S206, if the user's cursor 108 is not positioned outside of download area 104 for at least a predetermined duration, then it can be inferred that the user desires to continue to view the download area and its contents within (e.g., icon 106). Thus, download area 104 is not automatically closed and the contents within download area 104 remain displayed.

However, if the user did click on icon 106 and the user's cursor 108 is positioned outside of download area 104 for at least the predetermined duration, then it can be inferred that the user is no longer interested in viewing what is within download area 104 (e.g., the user's attention may be directed at window 110). In this regard, download area 104 can be closed automatically according to S208, thereby maximizing the area available in primary window 102 to display web pages. In the case where download area 104 is a separate window from primary window 102, download area 104 can also be closed automatically, thereby preventing the user from having to manage multiple windows. In some aspects, the predetermined duration is 300 milliseconds. However, the subject technology is not limited to this duration. Other suitable durations of time greater than or less than 300 milliseconds may be applied.

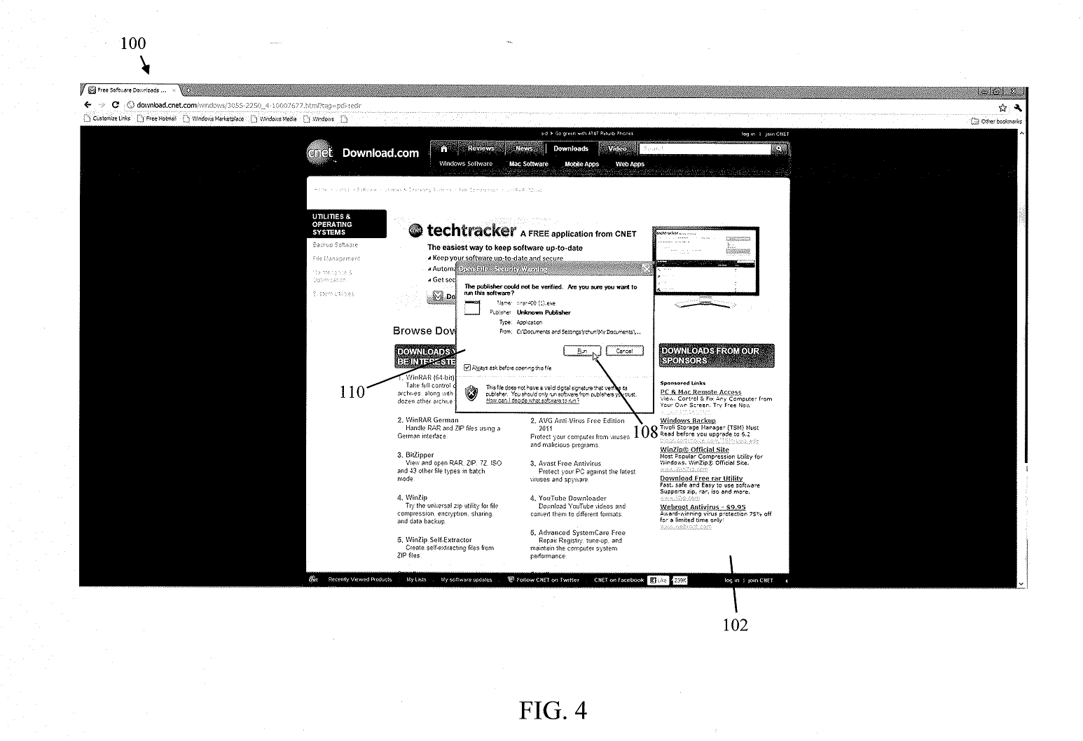

FIG. 4 illustrates an example of browser 100 having its download area 104 closed, in accordance with various aspects of the subject technology. As shown in this figure, cursor 108 is positioned outside of download area 104 and over window 110 after icon 106 has been clicked on. Thus, it can be inferred that the user's attention is directed at window 110. If the user's cursor 108 remains outside of download area 104 for at least the predetermined duration, then download area 104 may be closed. According to certain aspects, download area 104 may display multiple icons or other suitable content that represent downloaded objects. In some aspects, download area 104 does not automatically close until (i) an action has been performed on all the content (e.g., all the icons) displayed within download area 104 and (ii) the user's cursor 108 is positioned outside of download area 104 for at least the predetermined duration. This may be true either when download area 104 is integral with primary window 102 or when download area 104 is separate from primary window 102.

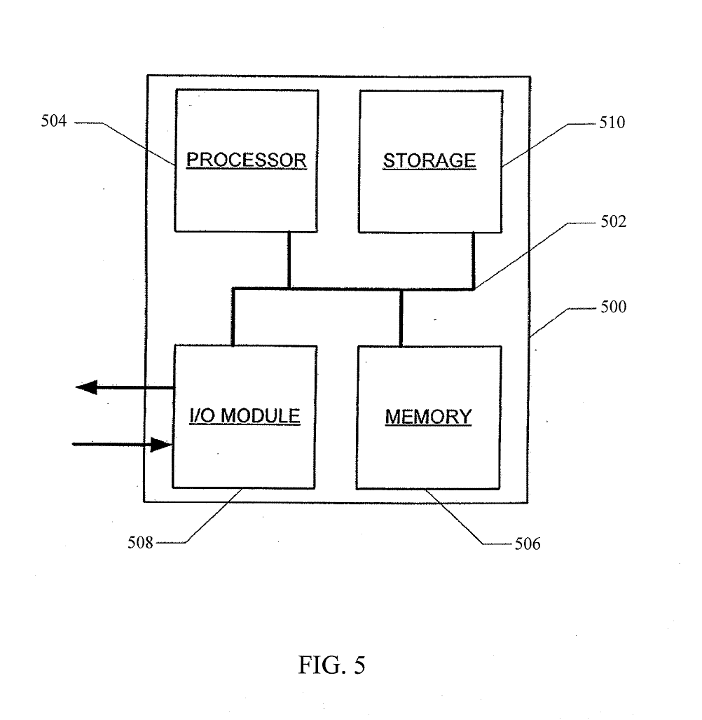

FIG. 5 is a block diagram illustrating components of controller 500, in accordance with various aspects of the subject disclosure. Controller 500 comprises processor module 504, storage module 510, input/output (I/O) module 508, memory module 506, and bus 502. Bus 502 may be any suitable communication mechanism for communicating information. Processor module 504, storage module 510, I/O module 508, and memory module 506 are coupled with bus 502 for communicating information between any of the modules of controller 500 and/or information between any module of controller 500 and a device external to controller 500. For example, information communicated between any of the modules of controller 500 may include instructions and/or data. In some aspects, bus 502 may be a universal serial bus. In some aspects, bus 302 may provide Ethernet connectivity.

In some aspects, processor module 504 may comprise one or more processors, where each processor may perform different functions or execute different instructions and/or processes. For example, one or more processors may execute instructions for managing a download area of a browser, and one or more processors may execute instructions for input/output functions.

Memory module 506 may be random access memory (“RAM”) or other dynamic storage devices for storing information and instructions to be executed by processor module 504. Memory module 506 may also be used for storing temporary variables or other intermediate information during execution of instructions by processor 504. In some aspects, memory module 506 may comprise battery-powered static RAM, which stores information without requiring power to maintain the stored information. Storage module 510 may be a magnetic disk or optical disk and may also store information and instructions. In some aspects, storage module 510 may comprise hard disk storage or electronic memory storage (e.g., flash memory). In some aspects, memory module 506 and storage module 510 are both a machine-readable medium.

Controller 500 is coupled via I/O module 508 to a user interface for providing information to and receiving information from an operator initializing variables for implementing a method for managing a download area of a browser. For example, the user interface may be a cathode ray tube (“CRT”) or LCD monitor for displaying information to an operator. The user interface may also include, for example, a keyboard or a mouse coupled to controller 500 via I/O module 508 for communicating information and command selections to processor module 504.

According to various aspects of the subject disclosure, methods described herein are executed by controller 500. Specifically, processor module 504 executes one or more sequences of instructions contained in memory module 506 and/or storage module 510. In one example, instructions may be read into memory module 506 from another machine-readable medium, such as storage module 510. In another example, instructions may be read directly into memory module 506 from I/O module 508, for example from an operator via the user interface. Execution of the sequences of instructions contained in memory module 506 and/or storage module 510 causes processor module 504 to perform methods to manage a download area of a browser. For example, a computational algorithm for managing a download area of a browser may be stored in memory module 506 and/or storage module 510 as one or more sequences of instructions. Information such as the predetermined duration may be communicated from processor module 504 to memory module 506 and/or storage module 510 via bus 502 for storage. In some aspects, the information may be communicated from processor module 504, memory module 506, and/or storage module 510 to I/O module 508 via bus 502. The information may then be communicated from I/O module 508 to an operator via the user interface 106.

One or more processors in a multi-processing arrangement may also be employed to execute the sequences of instructions contained in memory module 506 and/or storage module 510. In some aspects, hard-wired circuitry may be used in place of or in combination with software instructions to implement various aspects of the subject disclosure. Thus, aspects of the subject disclosure are not limited to any specific combination of hardware circuitry and software.

The term “machine-readable medium,” or “computer-readable medium,” as used herein, refers to any medium that participates in providing instructions to processor module 504 for execution. Such a medium may take many forms, including, but not limited to, non-volatile media, and volatile media. Non-volatile media include, for example, optical or magnetic disks, such as storage module 510. Volatile media include dynamic memory, such as memory module 506. Common forms of machine-readable media or computer-readable media include, for example, floppy disk, a flexible disk, hard disk, magnetic tape, any other magnetic medium, a CD-ROM, DVD, any other optical medium, punch cards, paper tape, any other physical mediums with patterns of holes, a RAM, a PROM, an EPROM, a FLASH EPROM, any other memory chip or cartridge, or any other medium from which a processor can read.

The subject technology may be applied to various web browsers such as Google Chrome™, Microsoft Internet Explorer™, Mozilla Firefox™, Opera Software's Opera™ Apple Safari™, or other suitable browsers.

The foregoing description is provided to enable a person skilled in the art to practice the various configurations described herein. While the subject technology has been particularly described with reference to the various figures and configurations, it should be understood that these are for illustration purposes only and should not be taken as limiting the scope of the subject technology.

There may be many other ways to implement the subject technology. Various functions and elements described herein may be partitioned differently from those shown without departing from the scope of the subject technology. Various modifications to these configurations will be readily apparent to those skilled in the art, and generic principles defined herein may be applied to other configurations. Thus, many changes and modifications may be made to the subject technology, by one having ordinary skill in the art, without departing from the scope of the subject technology.

It is understood that the specific order or hierarchy of steps in the processes disclosed is an illustration of exemplary approaches. Based upon design preferences, it is understood that the specific order or hierarchy of steps in the processes may be rearranged. Some of the steps may be performed simultaneously. The accompanying method claims present elements of the various steps in a sample order, and are not meant to be limited to the specific order or hierarchy presented.

A phrase such as “an aspect” does not imply that such aspect is essential to the subject technology or that such aspect applies to all configurations of the subject technology. A disclosure relating to an aspect may apply to all configurations, or one or more configurations. An aspect may provide one or more examples of the disclosure. A phrase such as an “aspect” may refer to one or more aspects and vice versa. A phrase such as an “embodiment” does not imply that such embodiment is essential to the subject technology or that such embodiment applies to all configurations of the subject technology. A disclosure relating to an embodiment may apply to all embodiments, or one or more embodiments. An embodiment may provide one or more examples of the disclosure. A phrase such an “embodiment” may refer to one or more embodiments and vice versa. A phrase such as a “configuration” does not imply that such configuration is essential to the subject technology or that such configuration applies to all configurations of the subject technology. A disclosure relating to a configuration may apply to all configurations, or one or more configurations. A configuration may provide one or more examples of the disclosure. A phrase such as a “configuration” may refer to one or more configurations and vice versa.

Furthermore, to the extent that the term “include,” “have,” or the like is used in the description or the claims, such term is intended to be inclusive in a manner similar to the term “comprise” as “comprise” is interpreted when employed as a transitional word in a claim.

The word “exemplary” is used herein to mean “serving as an example, instance, or illustration.” Any embodiment described herein as “exemplary” is not necessarily to be construed as preferred or advantageous over other embodiments.

A reference to an element in the singular is not intended to mean “one and only one” unless specifically stated, but rather “one or more.” The term “some” refers to one or more. All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

What is claimed is:

1. A computer-implemented method for managing a download area of a browser, the method comprising:
determining whether a user has performed an action on an icon, representing a downloaded object, displayed within the download area in a primary window of the browser, the download area configured to be active when the primary window is active;
determining whether the user's cursor is positioned outside of the download area for at least a predetermined duration after the user has performed the action on the icon; and
automatically closing the download area if the user has performed the action on the icon and if the user's cursor is positioned outside of the download area for at least the predetermined duration.

2. The method of claim 1, wherein the download area is integral with the primary window.

3. The method of claim 1, wherein the download area comprises a shelf that runs horizontally along a border of the primary window.

4. The method of claim 1, wherein the download area comprises a panel that runs vertically along a border of the primary window.

5. The method of claim 1, wherein the action performed on the icon is operable to open the downloaded object.

6. The method of claim 1, wherein the action performed on the icon comprises at least one of selecting the icon and clicking on the icon.

7. The method of claim 1, further comprising maintaining display of the download area if the user has not performed the action on the icon.

8. The method of claim 1, further comprising maintaining display of the download area if the user's cursor is not positioned outside of the download area for at least the predetermined duration.

9. The method of claim 1, wherein the predetermined duration is 300 milliseconds.

10. A machine-readable storage medium encoded with instructions executable by a processing system to perform a method for managing a download area of a browser, the instructions comprising code for:
determining whether a user has performed an action on an icon, representing a downloaded object, displayed within the download area in a primary window of the browser, the download area configured to be active when the primary window is active;
determining whether the user's cursor is positioned outside of the download area for at least a predetermined duration after the user has performed the action on the icon; and
automatically closing the download area if the user has performed the action on the icon and if the user's cursor is positioned outside of the download area for at least the predetermined duration.

11. The machine-readable storage medium of claim 10, wherein the action performed on the icon is operable to open the downloaded object.

12. The machine-readable storage medium of claim 10, wherein the instructions further comprise code for maintaining display of the download area if the user has not performed the action on the icon.

13. The machine-readable storage medium of claim 10, wherein the instructions further comprise code for maintaining display of the download area if the user's cursor is not positioned outside of the download area for at least the predetermined duration.

14. The machine-readable storage medium of claim 10, wherein the predetermined duration is 300 milliseconds.

15. A computer-implemented method for managing a download area of a browser, the method comprising:
determining whether a user has performed an action on each of a plurality of icons displayed within the download area in a primary window of the browser, each of the plurality of icons representing a downloaded object, the download area configured to be active when the primary window is active;
determining whether the user's cursor is positioned outside of the download area for at least a predetermined duration after the user has performed the action on each of the plurality of icons; and
automatically closing the download area if the user has performed the action on each of the plurality of icons and if the user's cursor is positioned outside of the download area for at least the predetermined duration.

16. The method of claim 15, wherein the action performed on each of the plurality of icons is operable to open a corresponding downloaded object.

17. The method of claim 15, further comprising maintaining display of the download area if the user has not performed the action on each of the plurality of icons.

18. The method of claim 15, wherein an action performed on one of the plurality of icons is different from an action performed on another of the plurality of icons.

19. The method of claim 15, further comprising maintaining display of the download area if the user's cursor is not positioned outside of the download area for at least the predetermined duration.

20. The method of claim 15, wherein the predetermined duration is 300 milliseconds.
